(19) United States
(12) Patent Application Publication
(10) Pub. No.: US 2012/0067808 A1
(43) Pub. Date: Mar. 22, 2012

(54) FILTRATION APPARATUS AND PROCESS WITH REDUCED FLUX IMBALANCE

(76) Inventors: Yatin TAYALIA, Bangalore (IN); Prasanna Rao DONTULA, Bangalore (IN); Upen J. BHARWADA, Scottsdale, AZ (US)

(21) Appl. No.: 12/883,238

(22) Filed: Sep. 16, 2010

(51) Int. Cl. C02F 1/44; B01D 65/00; B01D 63/00; B01D 63/12

(52) U.S. Cl. 210/321.66; 210/321.6; 210/321.83

(57) ABSTRACT

A filtration apparatus includes plurality of membrane modules arranged in series in a chamber. The membrane modules include at least one lead membrane module closer to an inlet port than the remaining membrane modules. A device coupled to the permeate collection conduit of the at least one lead membrane module is configured to apply a back pressure to permeate solution flowing in the permeate collection conduit of the at least one lead membrane module. By applying a back pressure, flux imbalance may be reduced within the apparatus.

### FIELD

This specification relates to membrane filtration, including nanofiltration, ultrafiltration and reverse osmosis, for example, seawater desalination by way of reverse osmosis.

### BACKGROUND

The following background discussion is not an admission that anything discussed below is citable as prior art or common general knowledge.

U.S. Pat. No. 4,046,685 describes a reverse osmosis apparatus comprising an elongated pressure container housing a plurality of semipermeable membrane cartridges in end-to-end relationship. A separate tap from the product water collector of the semipermeable membrane cartridge or cartridges nearest the inlet of the pressure container for introduction of pressurized feed liquid, produces a high quality water product.

U.S. Pat. No. 6,187,200 describes an apparatus and method for multistage reverse osmosis separation which comprises reverse osmosis membrane module units arranged with a booster pump provided in the concentrate flow channel between reverse osmosis membrane module units, wherein the total effective reverse osmosis membrane area of a module unit is in the range of 20-80% of that of the preceding module unit.

International PCT Publication No. WO/2005/082497 describes an apparatus and method for treating a solution of high osmotic strength, especially seawater and solutions of greater than 20 bar osmotic pressure, by passing the solution through a vessel containing spiral wound reverse osmosis or nanofiltration elements. The vessel contains at least three elements in series and at least two of these elements have standard specific flux that differ by at least 50%.

U.S. Pat. No. 7,410,581 describes a cross flow filtration apparatus for nanofiltration or reverse osmosis that has pressure vessels with a plurality of filter cartridges in each vessel. A feed port is provided at an intermediate position on the side of the vessel, and two permeate flows or branches exit opposite ends of the vessel, and the first branch has a characteristically high “upstream” flux and quality, while the second is of lesser flux and/or quality.

### Introduction

The following discussion is intended to introduce the reader to the more detailed discussion to follow, and not to limit or define any claim.

Reverse osmosis and nanofiltration are filtration methods that may be used to create potable water from seawater. Simple reverse osmosis systems, such as single stage desalination systems, use multiple modules of the same specification placed in line in a common pressure vessel. These systems are prone to flux imbalance wherein a lead module, located closer to the feed inlet of the vessel, operates at a higher flux than downstream modules located closer to the retentate inlet of the pressure vessel. Such systems may suffer from rapid fouling of the lead membrane modules and low production from the downstream modules. High permeate fluxes in the lead membrane modules also reduce cross-flow velocities in the rest of the pressure vessel. However, the multiple module configuration does have some advantages. In particular, a single pump and pressure vessel accommodate multiple modules and the common specification of the modules reduce venting requirements and allows the module to be rotated within or between vessels on site. The inventors therefore believe that it would be desirable to improve the performance of a multiple common module system without departing from its basic characteristics.

Described herein is an apparatus and process in which a back pressure is applied on the flow of permeate from the lead membrane module or modules, thereby reducing the flux imbalance between the membrane module or modules in the chamber. Relative to a conventional system, a lower flux is provided in the lead membrane module or modules, but higher flux and cross-flow velocities are in the rest of the chamber. A lower flux in the lead membrane module or modules may reduce fouling rate and improve the life of the lead membrane module or modules or allow an increase in the flow or pressure applied to the system without exceeding operational limits determined by conditions in the lead module. Further, the back pressure may be applied by way of an energy recovery device thus reducing the net energy use of the system for a given rate of production.

### DRAWINGS

FIG. 1 is a schematic view of an example of a filtration apparatus.

FIGS. 2 and 3 are graphs showing flux distribution among modules in two different filtration apparatuses.

FIGS. 4 and 5 are schematic views of further examples of a filtration apparatus.

For simplicity and clarity of illustration, where considered appropriate, reference numerals may be repeated among the drawings to indicate corresponding or analogous elements.

### DETAILED DESCRIPTION

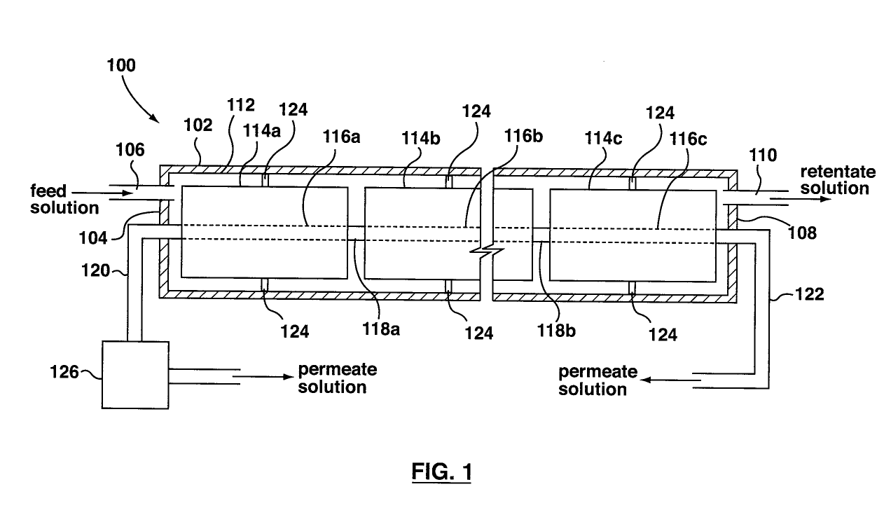

FIG. 1 shows an example of a filtration apparatus 100. The apparatus 100 includes a housing 102. A first end 104 of the housing 102 includes an inlet port 106 (which may be an end port as illustrated) for receiving a pressurized feed solution. A second end 108 of the housing 102 spaced apart from the first end 104 includes an outlet port 110 (which may be an end port as illustrated) for expelling a retentate solution. The housing 102 defines an elongate chamber or pressure vessel 112 between the inlet and outlet ports 106, 110.

The apparatus 100 includes a plurality of membrane modules or elements 114a, 114b, 114c arranged in series within the chamber 112. For clarity of illustration, only a few modules are shown, although an apparatus of this type may in practice be sized to hold six to eight or more membrane modules.

In the example illustrated, the apparatus 100 includes a lead or upstream membrane module 114a adjacent the inlet port 106, a last or tail membrane module 114c adjacent the outlet port 110, and at least one intermediate membrane module 114b disposed between the lead and tail membrane modules 114a, 114c. The lead membrane module 114a is closer to the inlet port 106 than the remaining downstream membrane modules 114b, 114c. The membrane modules 114a, 114b, 114c include permeate collection conduits 116a, 116b, 116c, respectively.

The membrane modules 114 comprise semi-permeable membranes that allow some components in a liquid solution to pass through while stopping other components. For example, each of the membrane modules 114 may be spiral-wound membrane modules. Such modules include sheet membranes wrapped about a permeable spacer to form an envelope that is spiral-wound with one or more feed spacers into a cylinder-shaped cartridge, with the permeable spacer in fluid communication with the respective permeate collection conduit 116. Each of the membrane modules 114 may include an end cap or plate (not shown) to provide shape and structural rigidity, which may aid in assuring a generally open fluid path for the feed solution to optimally reach exposed surfaces of the outside membranes of the membrane module, and which may also help resist telescoping or deformation under high pressure flows within the chamber. Other modules 114 may employ a different geometry or structural layout. For example, each of the membrane modules 114 may include hollow fiber membranes potted to an end manifold which is in fluid communication with a respective permeate collection conduit, so that permeate collected in the interior of the hollow fiber membranes may flow to the respective permeate collection conduit.

The permeate collection conduits 116a, 116b, 116c may be arranged along a central axis of the chamber 112. The permeate collection conduits 116a, 116b, 116c may terminate in couplings, and may be configured to interconnect to each other, e.g., via interconnectors 118a, 118b, so that permeate solution may flow axially between the permeate collection conduits 116a, 116b, 116c. Various configurations for the interconnectors 118a, 118b are possible, including, for example but not limited to, end caps described in U.S. Pat. No. 6,632,356 or couplers described in United States Publication No. 2006/0070940.

In the example illustrated, peripheral seals 124 may extend around the outer side of each of the membrane modules 114a, 114b, 114c, and seal against the inner wall of chamber 112 to assure that the feed solution proceeds downstream from the first end 104 to the second end 108 within the chamber 112, in series sequentially across the membrane surfaces of each of the membrane modules 114a, 114b, 114c.

The permeate collection conduit 116a of the lead membrane module 114a may connect to a first permeate outlet 120 that extends out of an end wall at the first end 104 the housing 102. The permeate collection conduit 116c of the tail membrane module 114c connects to a second permeate outlet 122 that extends out of an end wall at the second end 108 of the housing 102.

A device 126 is coupled to the permeate collection conduit 116a of the lead membrane module 114a, via the first permeate outlet 120, and is configured to apply a back pressure to the permeate solution flowing in the permeate collection conduit 116a of the lead membrane module 114a. The device 126 may be configured to apply around 2 to 20 bar of back pressure to the permeate solution in the permeate collection conduit 116a of the lead membrane module 114a. The device 126 may be configured to apply around 5 to 15 bar of back pressure to the permeate solution in the permeate collection conduit 116a of the lead membrane module 114a.

By applying a back pressure, the net driving pressure for the permeate solution in the lead membrane module 114a is reduced leading to a corresponding reduction in flux from the lead membrane module 114a and a corresponding increase in the pressure and velocity of retentate flowing through the remainder of the chamber 112. Higher average cross-flow velocities and pressure downstream may reduce the concentration polarization in the remaining downstream membrane modules 114b, 114c and raise the net driving pressure for permeate flow. Thus, similar overall permeate flows from a single apparatus 100 may be obtained while at the same time lowering the lead membrane module fluxes. A lower lead membrane module flux reduces their tendency to foul and lead membrane module life may be increased.

The device 126 may include an energy recovery device, for example, a turbine, which may be used to generate electricity. By recovering some of the energy of the permeate solution from the lead membrane module or modules 114a, the energy efficiency of the apparatus 100 may be improved. The device 126 may include a Pelton wheel turbine.

In some systems, for example when implemented in a large scale plant, the device 126 may be coupled to a plurality of apparatuses (each similar to the apparatus 100), with the apparatuses arranged generally in parallel. The device 126 may be configured to apply a back pressure to the permeate solution flowing from the lead membrane modules of each of the plurality of apparatuses.

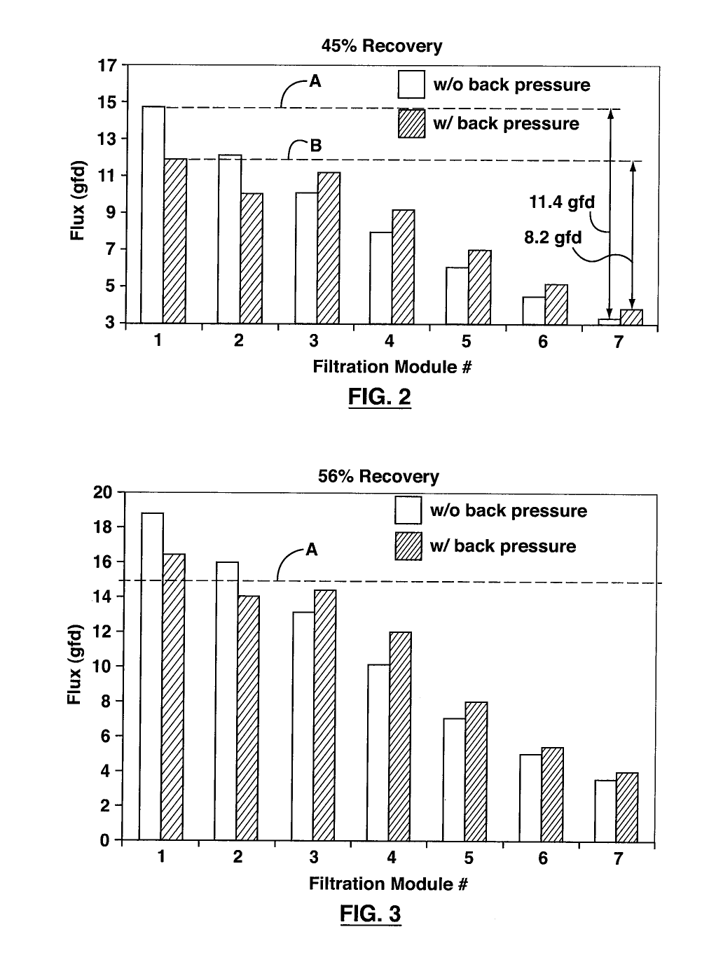

By way of example, theoretical fluxes were calculated for an apparatus similar to the apparatus 100, having seven membrane modules in total. FIG. 2 illustrates theoretical fluxes for the membrane modules, calculated with the apparatus operating at about 45% recovery, and assuming a flow rate of about 8 m³/h and a feed pressure of about 51 bar for a seawater feed solution having about 35,000 ppm of total dissolved solids.

To simulate a conventional arrangement, a back pressure of about 1 bar was assumed for all membrane modules, which is typical of the effects of piping and valves downstream of the pressure vessel. The conventional arrangement was compared to a new arrangement, wherein a back pressure of about 8 bar was applied to the membrane modules #1 and #2 (and a back pressure of about 1 bar was assumed for the remaining membrane modules).

Without a back pressure applied to the lead membrane modules, the flux for lead membrane module #1 (denoted by line A) was calculated to be about 15 gallons per square foot per day (gfd), and the flux for tail membrane module #7 was calculated to be about 3 gfd. With a back pressure of about 8 bar applied to the membrane modules #1 and #2, the flux for lead membrane module #1 (denoted by line B) was calculated to be about 12 gfd, and the flux for tail membrane module #7 was calculated to be about 4 gfd. Accordingly, the flux imbalance between the lead and tail membrane modules was decreased by about 4 gfd.

Extrapolating this example for a 10 million liters per day (MLD) seawater desalination plant, and using, for example, a single-nozzle horizontal-shaft Pelton wheel turbine with a nozzle of diameter 35 mm as an energy recovery mechanism to apply back pressure, calculations suggest that about 18 kW of energy may be recovered by the energy recovery mechanism, which represents about 3.3% of the overall energy consumption of the plant. Typically, energy represents a majority of operational cost, and thus energy savings of 3.3% may be significant for a large desalination project.

FIG. 3 also illustrates further theoretical fluxes for the same apparatus, calculated with the apparatus operating at about 56% recovery, and assuming a flow rate of about 8 m³/h and a feed pressure of about 65 bar for a salt water feed solution having about 35,000 ppm of total dissolved solids. The conventional arrangement, as described above, was compared to a new arrangement, wherein a back pressure of about 12 bar was applied to the membrane modules #1 and #2, and a back pressure of about 1 bar was assumed for the remaining membrane modules.

Without a back pressure applied to the lead membrane modules, the flux for lead membrane module #1 was calculated to be about 19 gfd, and the flux for tail membrane module #7 was calculated to be about 4 gfd. With a back pressure of about 12 bar applied to the membrane modules #1 and #2, the flux for lead membrane module #1 was calculated to be about 16 gfd, and the flux for tail membrane module #7 was calculated to be about 4 gfd. Accordingly, the flux imbalance between the lead and tail membrane modules was decreased by about 3 gfd.

Extrapolating this example for a 10 million liters per day (MLD) seawater desalination plant, and using, for example, a single-nozzle horizontal-shaft Pelton wheel turbine with a nozzle of diameter 35 mm as an energy recovery mechanism to apply back pressure, about 35 kW of energy may be recovered by the energy recovery mechanism, which represents about 4.6% of the overall energy consumption.

By applying a back pressure of 12 bar to the lead membrane modules, the apparatus may be operated at 56% recovery, and yet a similar flux was produced in the lead membrane module #1 (denoted by line A) as in operation without back pressure at 45% recovery. In other words, while operating with a similar flux for the lead membrane modules, applying a back pressure in accordance with this theoretical example may permit recovery to be raised from 45% to 56%. By operating at a higher recovery, plant productivity may be increased and the need for a second stage may be eliminated, reducing overall plant cost.

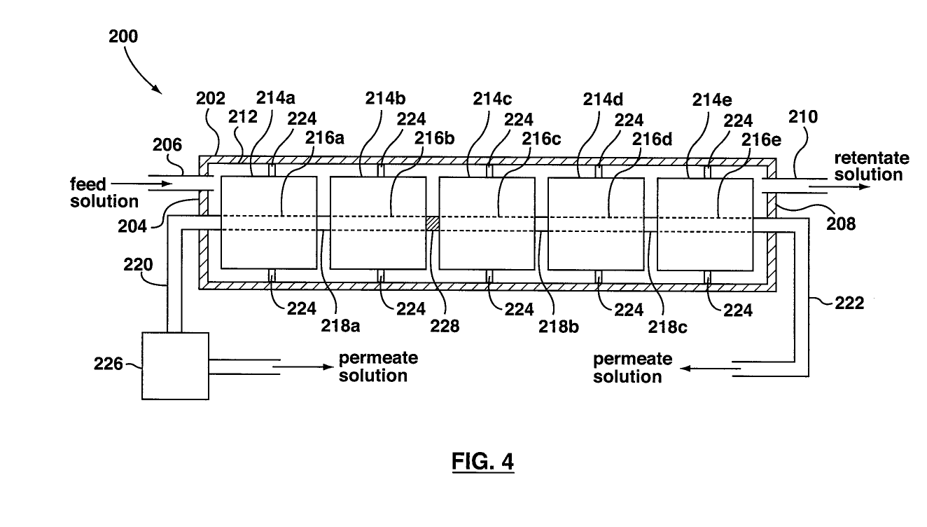

FIG. 4 shows another example of a filtration apparatus 200. The apparatus 200 includes a plurality of membrane modules 214a, 214b, 214c, 214d, 214e arranged in series within the chamber 212. For clarity of illustration, only five modules are shown.

In the example illustrated, the apparatus 200 includes two lead membrane modules 214a, 214b adjacent the inlet port 206, a last or tail membrane module 214e adjacent the outlet port 210, and two intermediate membrane modules 214c, 214d disposed therebetween. The lead membrane modules 214a, 214b are closer to the inlet port 206 than the remaining downstream membrane modules 214c, 214d, 214e.

In the example illustrated, a barrier element 228 may physically disconnect the permeate collection conduits 216b, 216c in order to block permeate solution from flowing between the permeate collection conduits 216b, 216c. Thus, permeate solution from the lead membrane modules 214a, 214b is segregated from permeate solution from the downstream membrane modules 214c, 214d, 214e. Permeate solution from the lead membrane modules 214a, 214b flows to the first permeate outlet 220 that extends out of an end wall of the housing 202. Permeate solution from the downstream membrane modules 214c, 214d, 214e flows to the second permeate outlet 222 that extends out of the end wall of the housing 202.

A device 226 is connected to the first permeate outlet 220 and is configured to apply back pressure to permeate collection conduits 216a, 216b of the lead membrane modules 214a, 214b.

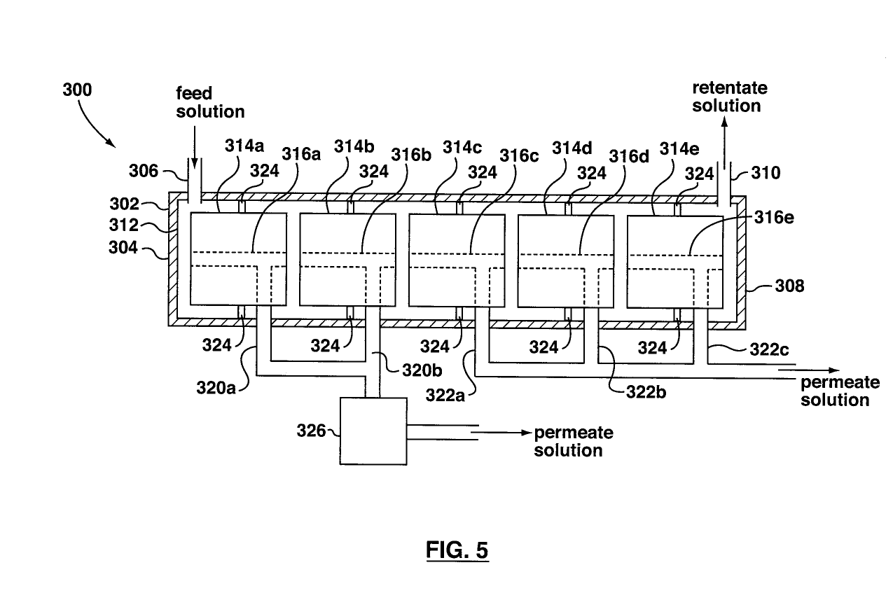

FIG. 5 shows another example of a filtration apparatus 300. The apparatus 300 includes a plurality of membrane modules 314a, 314b, 314c, 314d, 314e arranged in series within the chamber 312. For clarity of illustration, only five modules are shown.

In the example illustrated, the apparatus 300 includes two lead membrane modules 314a, 314b adjacent the inlet port 306 (which may be a side port as illustrated), a last or tail membrane module 314e adjacent the outlet port 310 (which may be a side port as illustrated), and two intermediate membrane modules 314c, 314d disposed therebetween. The lead membrane modules 314a, 314b are closer to the inlet port 306 than the remaining downstream membrane modules 314c, 314d, 314e.

In the example illustrated, the permeate collection conduit 316a of the membrane module 314a connects to permeate outlet 320a. The permeate collection conduit 316b of the membrane module 314b connects to permeate outlet 320b. The permeate outlets 320a, 320b each extend out of a side wall of the housing 302. Permeate outlets 322a, 322b, 322c also each extend out of the side wall of the housing 302.

A device 326 is connected to the permeate outlets 320a, 320b and is configured to apply back pressure to the permeate collection conduits 316a, 316b of the lead membrane modules 314a, 314b.

We claim:

1. A filtration apparatus, comprising:
a housing including an inlet port for receiving a feed solution and an outlet port for expelling a retentate solution, the housing defining a chamber between the inlet and outlet ports;
a plurality of membrane modules arranged in series in the chamber, the plurality of membrane modules including at least one lead membrane module closer to the inlet port than the remaining membrane modules, each of the plurality of membrane modules including a permeate collection conduit; and
a device coupled to the permeate collection conduit of the at least one lead membrane module and configured to apply a back pressure to permeate solution flowing in the permeate collection conduit of the at least one lead membrane module.

2. The apparatus of claim 1, wherein the back pressure is about 2 to 20 bar.

3. The apparatus of claim 1, wherein the back pressure is about 5 to 15 bar.

4. The apparatus of claim 1, wherein the device comprises an energy recovery mechanism.

5. The apparatus of claim 4, wherein the energy recovery mechanism comprises a turbine.

6. The apparatus of claim 4, wherein the energy recovery mechanism comprises a Pelton wheel turbine.

7. The apparatus of claim 1, wherein the permeate collection conduits are arranged generally along a central axis of the chamber and are interconnected so that permeate solution may flow between the permeate collection conduits.

8. The apparatus of claim 7, wherein the permeate collection conduit of the at least one lead membrane module is in fluid communication with a first permeate outlet that extends out of the housing.

9. The apparatus of claim 8, wherein the device is connected to the first permeate outlet and is configured to apply a back pressure to permeate solution flowing in the permeate collection conduit of the at least one lead membrane module.

10. The apparatus of claim 9, wherein the first permeate outlet extends out of an end wall or a side wall of the housing.

11. The apparatus of claim 1, wherein the permeate collection conduit of the at least one lead membrane module and the permeate collection conduits of downstream membrane modules are disconnected, so that permeate solution from the at least one lead membrane modules is segregated from permeate solution from the downstream membrane modules.

12. The apparatus of claim 1, wherein each of the membrane modules are spiral-wound reverse osmosis, nanofiltration or ultrafiltration membranes.

13. A filtration process, comprising:
flowing a pressurized feed solution in series through a plurality of membrane modules, the plurality of membrane modules including at least one lead membrane module;
collecting permeate solution from each of the plurality of membrane modules; and
collecting a retentate solution,
wherein a back pressure is applied to the permeate solution collected from the at least one lead membrane module.

14. The process of claim 13, wherein the back pressure is applied using an energy recovery mechanism.

15. The process of claim 14, further comprising using the energy recovery mechanism to generate electricity.

16. The process of claim 13, further comprising segregating the permeate solution collected from the at least one lead membrane module from the permeate solution collected from downstream membrane modules.

17. A system, comprising:
a plurality of filtration apparatuses, each of the filtration apparatuses including
a housing including an inlet port for receiving a feed solution and an outlet port for expelling a retentate solution, the housing defining a chamber between the inlet and outlet ports, and
a plurality of membrane modules arranged in series in the chamber, the plurality of membrane modules including at least one lead membrane module closer to the inlet port than the remaining membrane modules, each of the plurality of membrane modules including a permeate collection conduit; and
a device coupled to the permeate collection conduit of the at least one lead membrane module of each of the plurality of filtration apparatuses, the device configured to apply a back pressure to permeate solution flowing in the permeate collection conduit of the at least one lead membrane module of each of the plurality of filtration apparatuses.

18. The system of claim 17, wherein the device comprises an energy recovery mechanism.

19. The system of claim 18, wherein the energy recovery mechanism comprises a turbine.

20. The system of claim 18, wherein the energy recovery mechanism comprises a Pelton wheel turbine.
